(19) United States
(12) Patent Application Publication
(10) Pub. No.: US 2008/0231965 A1
(43) Pub. Date: Sep. 25, 2008

(54) Variable Focus Lens Package in Which a Sealing Ring is Used for Compensating for Volume Variations of Fluids Contained by the Package

(75) Inventor: Johannus Wilhelmus Weekamp, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,414

(22) PCT Filed: Jan. 24, 2005
(86) PCT No.: PCT/IB2005/050266

§ 371 Date: Jul. 25, 2006

(30) Foreign Application Priority Data
Jan. 30, 2004 (EP) 04100351.8
Apr. 29, 2004 (EP) 04101814.4

(51) Int. Cl. G02B 3/14

(52) U.S. Cl. 359/666

(57) ABSTRACT

A variable focus lens package (1) comprises an annular body (10) having a through-hole (11), which is closed off by means of lens members (30, 70), and which is sealed by means of sealing rings (50, 60). The through-hole (11) is filled with quantities of water (86) and oil (87), which are separated by a meniscus (88). A portion of the surface of the body (10) is covered with an electrically conducting layer (16). The shape of the meniscus (88) is variable under the influence of a voltage between this electrically conducting layer (16) and the water (86). In this way, the meniscus (88) is applicable as a lens having an adjustable focus. One of the sealing rings (60) is arranged such as to be capable of expanding and shrinking along with the fluids (86, 87), to an extent which is sufficient for compensating for volume variations in these fluids (86, 87).

The present invention relates to a variable focus lens package, comprising:
a body, which is provided with a through-hole for providing a light path through the body, wherein at least a surface layer of the body comprises an electrically conducting material;
covers for closing off the through-hole, which are optically transparent in the light path;
an electrically insulating fluid and an electrically conducting fluid, which are contained by a fluid chamber enclosed by the covers and an inner surface of the through-hole of the body, which are non-miscible, and which are in contact over a meniscus, wherein a shape of the meniscus is variable under the application of a voltage between the electrically conducting surface of the body and the electrically conducting fluid; and
an electrically insulating member covering at least the portion of the surface of
the body contacting the electrically conducting fluid.

A variable focus lens package in which light is refracted by a meniscus between two fluids, wherein the shape of the meniscus is variable under the influence of a voltage, is known. In general, such a variable focus lens package is provided with a through-hole for letting through light, which is closed off at both ends, whereby a closed fluid chamber for containing the fluids is obtained. One of the fluids has electrically insulating properties, whereas another of the fluids has electrically conducting properties. The fluids are non-miscible, and tend to form two fluid bodies separated by a meniscus. Functionally, the fluids have different indices of refraction.

For the purpose of applying a voltage, the variable focus lens package comprises two electrical connectors of which at least a portion is arranged at the outside of the lens package. A first electrical connector is separated from the electrically conducting fluid, whereas a second electrical connector is in direct contact with the electrically conducting fluid, or is capacitively coupled thereto.

WO 03/069380 discloses a variable focus lens package in which an inner surface of the through-hole is covered by a hydrophobic fluid contact layer. When no voltage is applied, the wettability of the fluid contact layer with respect to the electrically insulating fluid differs from the wettability of the fluid contact layer with respect to the electrically conducting fluid. Due to an effect referred to as electrowetting, the wettability of the fluid contact layer with respect to the electrically conducting fluid is variable under the application of a voltage between the first connector and the second connector. A change of the wettability of the fluid contact layer leads to a change of a contact angle of the meniscus at a line of contact between the fluid contact layer and the two fluids, whereby the shape of the meniscus is adjusted. Hence, the shape of the meniscus is dependent on the applied voltage.

A problem associated with the variable focus lens package is that the volume of the fluids changes under the influence of the temperature. In case the temperature increases, the volume of the fluids increases as well, as a result of which breaking of a cover may occur. In case the temperature decreases, the volume of the fluids decreases as well, as a result of which air bubbles and/or vacuum cavities may be formed in the fluids. The presence of air bubbles and/or vacuum cavities hinders the operation of the variable focus lens package to such an extent that the variable focus lens package can not function properly any more.

In order to solve the problem, solutions are proposed, which are aimed at allowing for volume variations of the fluid chamber. More in particular, the solutions are aimed at adapting the volume of the fluid chamber to the volume of the fluids enclosed by it.

JP 2002162506 discloses a variable focus lens package in which a space is formed in the body, wherein the space is covered by a film-shaped flexible member. When the volume of the fluids inside the fluid chamber changes, a deformation of the flexible member guarantees that the volume of the fluid chamber remains the same as the volume of the fluids contained by it. A deformation of the flexible member caused by expansion of the fluids is allowed for by the space in the body. By means of suitable deformations of the flexible member, volume variations of the fluids are compensated for, while the size of the variable focus lens package as a whole does not change.

It is an objective of the present invention to provide a newly designed variable focus lens package, in which volume variations of the fluids are compensated for in a relatively simple manner. Furthermore, the variable focus lens package according to the present invention must be suitable for application in a mobile phone, and must therefore be capable of meeting all requirements associated with such an application, including requirements pertaining to compactness and sturdiness.

The set objective is achieved by a variable focus lens package, comprising:
a body, which is provided with a through-hole for providing a light path through the body, wherein at least a surface layer of the body comprises an electrically conducting material;
covers for closing off the through-hole, which are optically transparent in the light path;
an electrically insulating fluid and an electrically conducting fluid, which are contained by a fluid chamber enclosed by the covers and an inner surface of the through-hole of the body, which are non-miscible,-and which are in contact over a meniscus, wherein a shape of the meniscus is variable under the application of a voltage between the electrically conducting surface of the body and the electrically conducting fluid;
an electrically insulating member covering at least the portion of the surface of the body contacting the electrically conducting fluid;
sealing means for sealing the fluid chamber; and
at least one expansion member which is at least partially flexible and which is part of a circumscription of the fluid chamber, wherein said expansion member is capable of compensating for variations of the volume of the fluids by keeping a pressure prevailing inside the fluid chamber at a substantially fixed level, and wherein said expansion member comprises at least a portion of the sealing means.

In the variable focus lens package according to the present invention, the fluid chamber is sealed by means of sealing means, which prevent the fluids from leaking out of the fluid chamber through a space between the body and the covers. According to an important aspect of the present invention, at least a portion of the sealing means has two important functions. In the first place, this portion of the sealing means is arranged to perform the function of sealing the fluid chamber. In the second place, this portion of the sealing means is arranged to perform the function of compensating for variations of the volume of the fluids contained by the fluid chamber. For example, the sealing means comprise a rubber sealing ring, which is capable of expanding and shrinking to an extent which is sufficient for compensating for volume variations of the fluids.

According to the present invention, at least a portion of the sealing means is part of an expansion member which is at least partially flexible, which is part of a circumscription of the fluid chamber, and which is capable of compensating for variations of the volume of the fluids by keeping a pressure prevailing inside the fluid chamber at a substantially fixed level. In a preferred embodiment, the expansion member does not only comprise at least a portion of the sealing means, but also a resilient member for biasing the portion of the sealing means which is part of the expansion member against the fluids inside the fluid chamber. In this way; it is ensured that an undesired formation of space between the portion of the sealing means and the fluids does not occur, so that there is no danger of an undesired formation of air bubbles and/or vacuum cavities in the fluid chamber. In case the portion of the sealing means which is part of the expansion member comprises a rubber sealing ring, the resilient member may for example comprise a metal resilient ring surrounding the sealing ring.

An important advantage of the present invention is that the proposed measures for compensating for volume variations of the fluids contained by the fluid chamber are relatively simple. The sealing means are present anyway, and may be designed such that a at least a portion of these means is not only capable of sealing the fluid chamber, but also of compensating for volume variations of the fluids contained by the fluid chamber. Moreover, a relatively robust construction is obtained. For example, in case a rubber sealing ring is used, the variable focus lens package is more robust than in case film-shaped flexible members are used.

The present invention will now be explained in greater detail with reference to the figures, in which similar parts are indicated by the same reference signs, and in which:

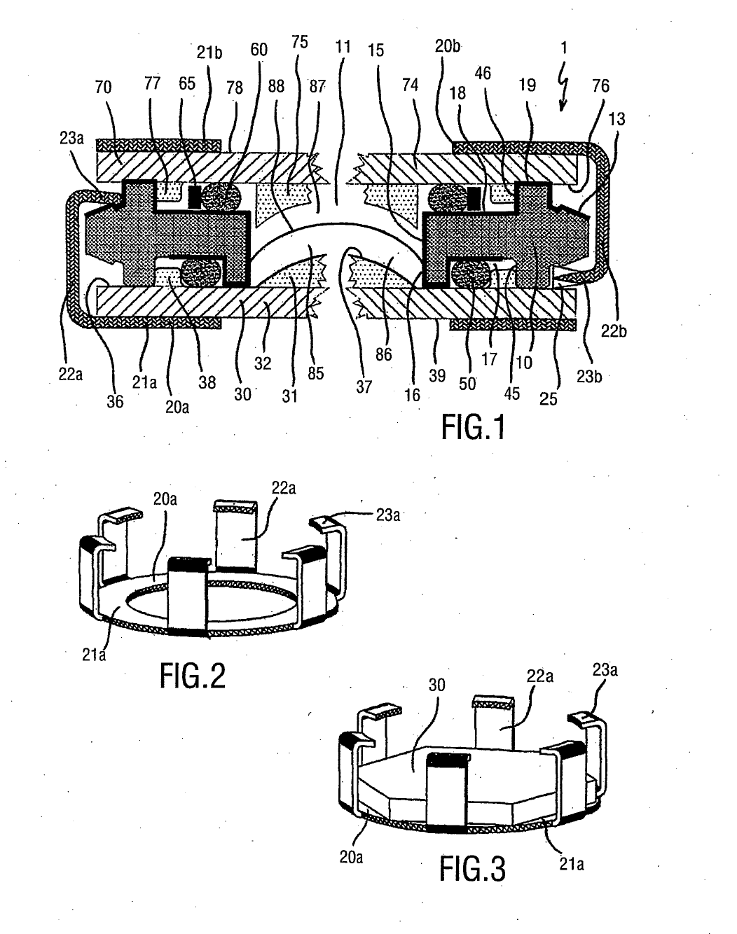

FIG. 1 diagrammatically shows a sectional view of a variable focus lens package according to a preferred embodiment of the present invention;

FIGS. 2-6 diagrammatically illustrate a way of assembling the variable focus lens package according to the preferred embodiment of the present invention; and

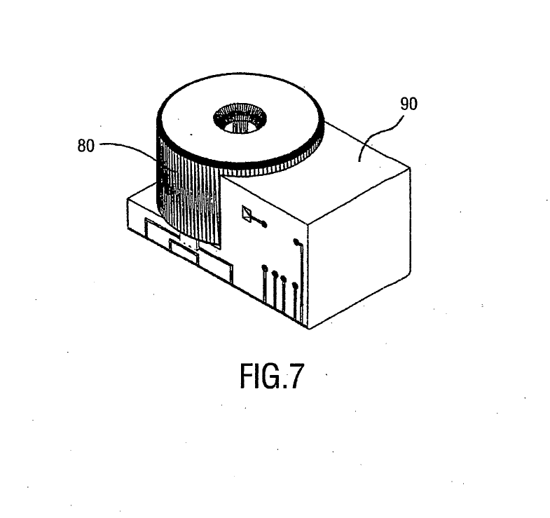

FIG. 7 diagrammatically shows a perspective view of a barrel containing the variable focus lens package according to the preferred embodiment of the present invention, and a camera module onto which the barrel is fitted.

FIG. 1 diagrammatically shows a variable focus lens package 1 according to a preferred embodiment of the present invention. FIGS. 2-6 diagrammatically illustrate a way of assembling the variable focus lens package 1.

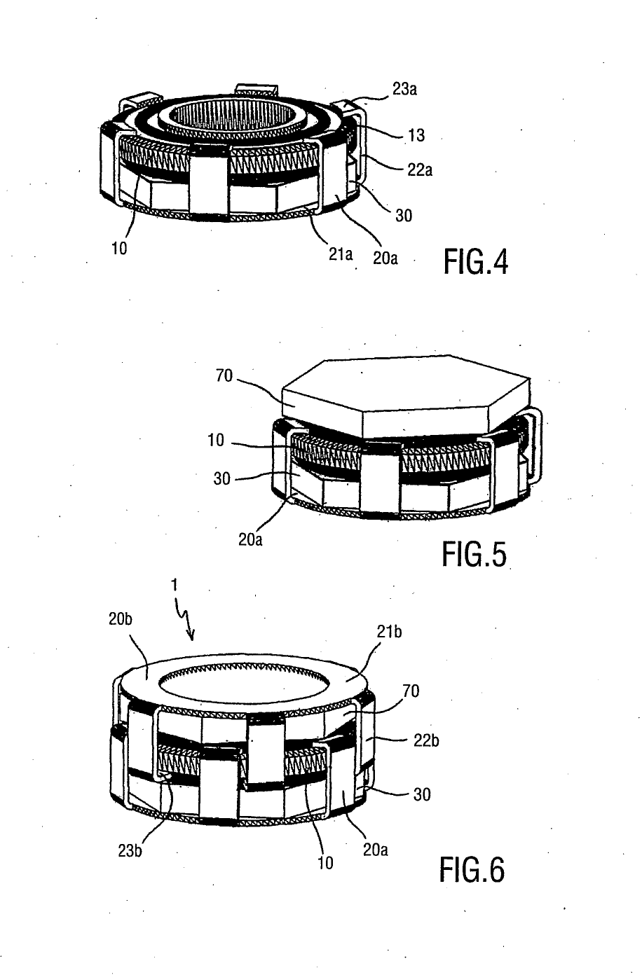

The variable focus lens package 1 comprises an annular body 10, which comprises a through-hole 11. It is clear from FIG. 4 that in this example, the through-hole 11 is shaped as a cylinder having a circular transverse section. The body 10 may for example be a plastic element, and is at least partially covered by a layer comprising electrically conducting material, such as metal. The electrically conducting layer is covered by a layer comprising an electrically insulating material, such as parylene, whereas the electrically insulating layer is covered by a layer comprising a hydrophobic material. The three layers covering a portion of the body 10 are diagrammatically depicted in FIG. 1 by means of a relatively thick line, which is indicated by reference numeral 16.

Alternatively, the insulating member may be an insulating part that is assembled separately to the inner side of the body.

It is understood that at least one of the covers may be integrated in the body. The through hole 11 forms then a cavity with the integrated cover.

At both a bottom side and a top side of the body 10, an outer portion of the body 10 comprises a bevelling surface 13. Furthermore, at a bottom side, the body 10 is provided with an annular groove 17. At a top side, the body 10 comprises two planar annular portions 18, 19, wherein an inner annular portion 18 extends from an inner circumference of the body 10 in the direction of an outer circumference of the body 10, and wherein an outer annular portion 19 is situated at a position between the inner circumference and the outer circumference. The outer annular portion 19 is located at a higher level than the inner annular portion 18, and the transition between the annular portions 18, 19 is formed by an upright wall 46.

A through-hole 11 of the body 10 is closed off by means of a bottom lens member 30 which is located at the bottom side of the body 10 and a top lens member 70 which is located at the top side of the body 10. Both lens members 30, 70 are formed as so-called replica lenses. Such lenses comprise a glass base plate 32, 74 and a plastic lens body 31, 75, and are manufactured in a manner known per se, with the use of a mould for moulding the plastic and UV-light for curing the plastic inside the mould. In FIG. 1, a central portion of the lens bodies 31, 75 of the lens members 30, 70 is not shown, as the exact shape of the lens bodies 31, 75 is not relevant in the light of the present invention.

A top surface 36 of the bottom lens member 30 is covered by a layer 37, which is both hydrophilic and electrically conducting, and which comprises for example metal.

The variable focus lens package 1 comprises a bottom sealing ring 50 and a top sealing ring 60 for sealing a fluid chamber 85 which is delimited by an inner surface 15 of the through-hole 11 of the body 10, a bottom surface 76 of the top lens member 70 and the top surface 36 of the bottom lens member 30. The top sealing ring 60 is located between the inner annular portion 18 of the body 10 and the base plate 74 of the top lens member 70, whereas the bottom sealing ring 50 is located in the groove 17 at the bottom side of the body 10, and contacts the top surface 36 of the bottom lens member 30. Both the bottom sealing ring 50 and the top sealing ring 60 may for example be made of rubber.

At both the top surface 36 of the bottom lens member 30 and the bottom surface 76 of the top lens member 70, a positioning ring 38, 77 is arranged on the lens members 30, 70. The positioning rings 38, 77 play a role in aligning the lens members 30, 70 with respect to each other and with respect to the through-hole 11 of the body 10. On the one hand, an outer diameter of a bottom positioning ring 38 is chosen such that when the bottom lens member 30 is put in place with respect to the body 10, an outer circumference of the bottom positioning ring 38 contacts an outer wall 45 of the groove 17, without the presence of play. In this way, a central axis of the lens body 31 of the bottom lens member 30 is exactly aligned with a central axis of the through-hole 11 of the body 10. On the other hand, an outer diameter of a top positioning ring 77 is chosen such that when the top lens member 70 is put in place with respect to the body 10, an outer circumference of the top positioning ring 77 contacts the upright wall 46, without the presence of play. In this way, a central axis of the lens body 75 of the top lens member 70 is exactly aligned with the central axis of the through-hole 11 of the body 10, and consequently also with the central axis of the lens body 31 of the bottom lens member 30.

For the purpose of fixing the various lens package elements 10, 30, 50, 60, 70, with respect to each other, two clamping units 20a, 20b are provided. The clamping units 20a, 20b comprise a ring 21a, 21b and a number of clamping arms 22a, 22b extending from an outer circumference of said ring 21a, 21b. Ends of the clamping arms 22a, 22b are provided with bent portions 23a, 23b. FIG. 2 is a perspective view of a bottom clamping unit 20a.

In the variable focus lens package 1, the clamping arms 22a, 22b extend substantially perpendicular to the relevant ring 21a, 21b. This appearance of the clamping units 20a, 20b is obtained on the basis of an initial form of the clamping units 20a, 20b, in which the clamping arms 22a, 22b extend entirely in the same plane as the relevant ring 21a, 21b, by bending the ends of the clamping arms 22a, 22b such as to obtain the bent portions 23a, 23b, and by changing the orientation of the clamping arms 22a, 22b with respect to the relevant ring 21a, 21b. It will be understood that for the purpose of shaping the clamping units 20a, 20b in this way, it is important that the clamping units 20a, 20b comprise bendable material.

The bottom clamping unit 20a is arranged such as to clamp the bottom lens member 30 against the body 10, wherein the bottom sealing ring 50 is clamped between the bottom lens member 30 and the body 10. During assembly of the variable focus lens package 1, ends of the bent portions 23a of the clamping arms 22a are guided by the bevelling surface 13 at the top side of the body 10. In the process, the ends of the bent portions 23 scratch through the hydrophobic layer and the electrically insulating layer, and consequently come into direct contact with the electrically conducting layer.

A top clamping unit 20b is arranged such as to clamp the top lens member 70 against the body 10, wherein the top sealing ring 60 is clamped between the top lens member 70 and the body 10. Ends of the bent portions 23b of the clamping arms 22b contact the layer 37 covering the top surface 36 of the bottom lens member 30. In the shown example, the ends of the bent portions 23b comprise elastic fingers 25 which are biased to spring outwards, so that the ends are firmly clamped between the bevelling surface 13 at the bottom side of the body 10 and the top surface 36 of the bottom lens member 30. In this way, contact between the ends of the bent portions 23b and the layer 37 covering the top surface 36 of the bottom lens member 30 is guaranteed.

The variable focus lens package 1 comprises a quantity of electrically conducting fluid 86, which may for example comprise water containing a salt solution. In the following, for the sake of simplicity, the electrically conducting fluid 86 will be referred to as “water”. Furthermore, the variable focus lens package 1 comprises a quantity of electrically insulating fluid 87, which may for example comprise a silicone oil or an alkane. In the following, for the sake of simplicity, the electrically insulating fluid 87 will be referred to as “oil”.

The water 86 and the oil 87 constitute two separate fluid bodies inside the fluid chamber 85. Functionally, the water 86 and the oil 87 have different indices of refraction. The densities of the water 86 and the oil 87 are preferably equal, so that the operation of the variable focus lens package 1 is not influenced by its orientation, in other words, so that the operation of the lens package 1 is not influenced by gravitational effects between the water 86 and the oil 87.

The water 86 is situated at a bottom side of the fluid chamber 85, and the oil 87 is situated at a top side of the fluid chamber 85. The water 86 and the oil 87 are separated by a meniscus 88. The shape of this meniscus 88 is variable under the influence of a voltage between the electrically conducting layer of the body 10 and the water 86, as the wettability of the hydrophobic layer with respect to the water 86 is variable under the application of a voltage. In the variable focus lens package 1, connectors for supplying the voltage are constituted by the clamping units 20a, 20b. In this respect, for completeness' sake, it is noted that the ends of the bent portions 23a of the clamping arms 22a of the bottom clamping unit 20a are in contact with the electrically conducting layer of the body 10, and that the ends of the bent portions 23b of the clamping arms 22b of the top clamping unit 20b are in contact with the water 86, through the electrically conducting layer 37 of the bottom lens member 30.

The top sealing ring 60 is surrounded by a resilient ring 65, which, for example, is made of metal. The top sealing ring 60 and the surrounding resilient ring 65 are arranged such as to be able to expand and to shrink. In this way, the top sealing ring 60 and the surrounding resilient ring 65 are capable of compensating for variations of the volume of the water 86 and the oil 87 by keeping a pressure prevailing inside the fluid chamber 85 at a substantially fixed level. Variation of the volume of the water 86 and the oil 87 may occur during operation of the variable focus lens package 1, for example under the influence of the temperature. If the variation of the volume of the water 86 and the oil 87 is not compensated for, air bubbles and/or vacuum cavities arise in these fluids 86, 87, or one of the lens members 30, 70 breaks. In both cases, the variable focus lens package 1 becomes useless.

When the temperature increases, the volume of the fluids 86, 87 increases. In that case, both the top sealing ring 60 and the resilient ring 65 are forced to expand, wherein the pressure prevailing inside the fluid chamber 85 remains substantially at a constant level. During the expansion, a bottom portion of the top sealing ring 60 slides along the inner annular portion 18 of the body, and a top portion of the top sealing ring 60 slides along the bottom surface 76 of the top lens member 70, wherein the sealing function of the top sealing ring 60 is maintained.

When the temperature decreases, the volume of the fluids 86, 87 decreases. In that case, the top sealing ring 60 is forced to shrink by the resilient ring 65, wherein the pressure prevailing inside the fluid chamber 85 remains substantially at a constant level. During the shrinkage, like during the expansion, a bottom portion of the top sealing ring 60 slides along the inner annular portion 18 of the body, and a top portion of the top sealing ring 60 slides along the bottom surface 76 of the top lens member 70, wherein the sealing function of the top sealing ring 60 is maintained.

On the basis of the preceding two paragraphs, it is clear that it is important that the top sealing ring 60 is slidably arranged with respect to the surface of the inner annular portion 18 of the body 10 on the one hand and the bottom surface 76 of the top lens member 70 on the other hand. In order to facilitate the sliding, a film containing grease or the like may be arranged between the top sealing ring 60 and said surfaces.

The variable focus lens package 1 is assembled in several steps, which are listed in the following. The assembly starts with the bottom clamping unit 20a, which is shown in FIG. 2.

During a first assembly step, the bottom lens member 30 is placed on top of the ring 21a of the bottom clamping unit 20a In the process, the base plate 32 of the bottom lens member 30 is positioned between the clamping arms 22a of the bottom clamping unit 20a.

FIG. 3 shows an entirety of lens package elements 20a, 30, which is obtained after the first assembly step.

During a second assembly step, the bottom sealing ring 50 is positioned in the groove 17 at the bottom side of the body 10. Subsequently, the body 10 is put in place with respect to the bottom lens member 30, wherein the outer circumference of the bottom positioning ring 38 contacts the outer wall 45 of the groove 17, whereby the position of the body 10 is fixed with respect to the bottom lens member 30 in a transversal direction.

During a third assembly step, the bottom clamping unit 20a is bent around the body 10 and the bottom lens member 30, wherein the ring 21a of the bottom clamping unit 20a rests on a bottom surface 39 of the bottom lens member 30, and wherein the bent portions 23a of the clamping arms 22a rest on the top side of the body 10, at a position beyond the bevelling surface 13. In the process, ends of the bent portions 23a of the clamping arms 22a are guided by the bevelling surface 13 at the top side of the body 10, wherein the ends of the bent portions 23 scratch through the hydrophobic layer and the electrically insulating layer, and consequently come into direct contact with the electrically conducting layer.

FIG. 4 shows an entirety of lens package elements 10, 20a, 30, 50, which is obtained after the third assembly step.

During a fourth assembly step, the top sealing ring 60 and the resilient ring 65 are placed on top of the inner annular portion 18 at the top side of the body 10.

During a fifth assembly step, a predetermined quantity of water 86 is put in the open container which is delimited by the top surface 36 of the bottom lens member 30 and the inner surface 15 of the through-hole 11 of the body 10. Subsequently, the open container is further filled with oil 87.

During a sixth assembly step, the top lens member 70 is put in place with respect to the body 10, wherein the outer circumference of the top positioning ring 77 contacts the upright wall 46, whereby the position of the top lens member 70 is fixed with respect to the body 10 in a transversal direction.

FIG. 5 shows an entirety of lens package elements 10, 20a, 30, 50, 60, 65, 70, which is obtained after the sixth assembly step.

During a seventh assembly step, the top clamping unit 20b is put in place, and is bent around the body 10 and the top lens member 70, wherein the ring 21b of the top clamping unit 20b rests on a top surface 78 of the top lens member 70, and wherein the bent portions 23b of the clamping arms 22b are clamped between the bevelling surface 13 at the bottom side of the body 10 and the top surface 36 of the bottom lens member 30. Consequently, the ends of the bent portions 23b come into direct contact with the electrically conducting layer 37 of the bottom lens member 30.

The result of the seven assembly steps is the variable focus lens package 1 according to the preferred embodiment of the present invention. A diagrammatical perspective view of this variable focus lens package 1 is shown in FIG. 6. The focus of this lens package 1 may be varied by applying a voltage through the connectors of this lens package 1, which are constituted by the clamping units 20a, 20b.

In FIG. 7, a barrel 80 is shown, wherein the variable focus lens package 1 (not shown in FIG. 7) is accommodated in said barrel 80. Additional to the variable focus lens package 1, the barrel 80 may accommodate more optical elements.

The barrel 80 containing the variable focus lens package 1 constitutes a robust unit, which is suitable for application in a mobile phone. FIG. 7 diagrammatically shows a combination of the barrel 80 and a camera module 90. By means of the connectors of the variable focus lens package 1, which comprise the clamping units 20a, 20b, the lens package 1 is connected to the camera module 90, which is equipped with a driver and additional components for the lens package 1. The electrical connections between the variable focus lens package 1 and the camera module 90 may be realized in any suitable way, for example by means of soldering, welding, clamping or glueing.

The variable focus lens package 1 comprises a series of three lenses. Light which falls on the variable focus lens package 1 follows a light path through the lens package 1, wherein the light passes the top lens member 70, the water 86, the oil 87 and the meniscus 88 between these two fluids, and the bottom lens member 30. By varying the shape of the meniscus 88 between the water 86 and the oil 87, it is possible to focus the light. The way in which the shape of said meniscus 88 is varied will be explained in the following.

The bottom clamping unit 20a is connected to the electrically conducting layer of the body 10, through the clamping arms 22a and the bent portions 23a of these clamping arms 22a. The top clamping unit 20b is connected to the water 86, through the clamping arms 22b and the bent portions 23b of these clamping arms 22b, and the layer of electrically conducting material which is provided on the top surface 36 of the bottom lens member 30. When no voltage is applied between the clamping units 20a, 20b, the wettability of the hydrophobic layer on the inner surface 15 of the through-hole 11 of the body 10 with respect to the water 86 differs from the wettability of said layer with respect to the oil 87. Due to an effect referred to as electrowetting, the wettability of the hydrophobic layer with respect to the water 86 is variable under the application of a voltage between the clamping units 20a, 20b. A change of the wettability of the hydrophobic layer leads to a change of a contact angle of the meniscus 88 between the water 86 and the oil 87, at a line of contact between the hydrophobic layer and the two fluids 86, 87, whereby the shape of the meniscus 88 is adjusted. Hence, the shape of the meniscus 88 is dependent on the applied voltage. As the meniscus 88 is positioned in the light path and serves for refracting light, this meniscus 88 may be considered as a lens having a variable focus.

In order for the variable focus lens package 1 to be suitable for application in a mobile phone, the dimensions of the various package elements need to be relatively small. For example, an inner diameter of the body 10 is 3 mm, an outer diameter of the body 10 is 6 mm, and a height of the body 10 is 1 mm.

Summarizing, the variable focus lens package 1 may be described as follows: the variable focus lens package 1 comprises an annular body 10 having a through-hole 11, which is closed off by means of lens members 30, 70, and which is sealed by means of sealing rings 50, 60. The through-hole 11 is filled with quantities of water 86 and oil 87, which are separated by a meniscus 88. The various lens package elements are fixed with respect to each other by means of clamping units 20a, 20b. By this arrangement, a very compact and robust lens package 1 is obtained.

A portion of the surface of the body 10 is covered with an electrically conducting layer. The shape of the meniscus 88 is variable under the influence-of a voltage between this electrically conducting layer and the water 86. In this way, the meniscus 88 is applicable as a lens having an adjustable focus.

One of the sealing rings 50, 60 of the variable focus lens package 1 is arranged such as to be capable of expanding and shrinking along with the water 86 and the oil 87, to an extent which is sufficient for compensating for volume variations of the fluids 86, 87, which are caused by temperature variations. In this way, breakage of a lens member 30, 70 and formation of air bubbles and/or vacuum cavities inside the variable focus lens package 1 is prevented.

It will be clear to a person skilled in the art that the scope of the present invention is not limited to the examples discussed in the foregoing, but that several amendments and modifications thereof are possible without deviating from the scope of the present invention as defined in the attached claims.

For example, it will be understood that it is possible to apply other means than the shown rubber sealing rings 50, 60 for sealing the fluid chamber 85 of the variable focus lens package 1. However, it is important that at least a portion of the sealing means is flexible enough to be capable of compensating for volume variations of the water 86 en the oil 87.

It is not necessary to apply the clamping units 20a, 20b as connectors of the variable focus lens package 1, although this is a very advantageous option. Within the scope of the present invention, it is possible to arrange additional connectors, wherein one connector is in contact with an electrically conducting portion of the body 10, and wherein another connector is in contact with the water 86 inside the fluid chamber 85 of the variable focus lens package 1.

The base plate 32, 74 of the lens members 30, 70 may have any suitable shape, and may for example be square or hexagonal. The latter is the case in the shown variable focus lens package 1. The shape of the clamping units 20a, 20b, in particular the positions of the clamping arms 22a, 22b, is adapted to the shape of the base plates 32, 74.

In the shown embodiment of the variable focus lens package 1 according to the present invention, a bottom lens member 30 and a top lens member 70 are applied, so that the lens package 1 actually comprises a series of three lenses. It is not necessary that additional lenses are applied. Instead, it is possible that at least one of the lens members 30, 70 is replaced by a cover having no functioning in focussing the light.

For the purpose of compensating for variations of the volume of the water 86 and the oil 87, various solutions exist, which boil down to the application of an expansion member. The solution which is applied in the shown variable focus lens package 1 comprises a resilient ring 65 surrounding the top sealing ring 60.

The variable focus lens package 1 may be applied in hand-held apparatus, such as mobile phones and optical scanning devices for use in digital recording equipment.

A number of lens packages 1 may be positioned in a row, wherein the through-holes 11 of the lens packages 1 are aligned with respect to each other, in order to create a zoom lens.

The lens package 1 according to the present invention is particularly intended for application in a camera, which further comprises an image sensor and an interconnecting body, wherein the interconnecting body comprises electrically conductive tracks arranged on a first surface and a second surface of the interconnecting body, and wherein the electrically conductive tracks are shaped such as to be able to establish a connection between both the image sensor and the variable focus lens package 1 to driver electronics therefore, or to contact pads. In this respect, it is noted that a combination of a barrel 80 containing the variable focus lens package 1 and a camera module 90 has already been described in the foregoing.

The camera may be part of the above-mentioned hand-held apparatus, which may further comprise input means, information processing means and display means.

1. Variable focus lens package (1), comprising:
a body (10), which is provided with a through-hole (11) for providing a light path through the body (10), wherein at least a surface layer of the body (10) comprises an electrically conducting material and which body is provided with covers (30, 70) for closing off the through-hole (10), which are optically transparent in the light path;
an electrically insulating fluid (87) and an electrically conducting fluid (86), which are contained by a fluid chamber (85) enclosed by the covers (30, 70) and an inner surface (15) of the through-hole (11) of the body (10), which are non-miscible, and which are in contact over a meniscus (88), wherein a shape of the meniscus (88) is variable under the application of a voltage between the electrically conducting surface of the body (10) and the electrically conducting fluid (86);
an electrically insulating member covering at least the portion of the surface of the body (10) contacting the electrically conducting fluid (86);
sealing means (50, 60) for sealing the fluid chamber (85); and
at least one expansion member (60, 65) which is at least partially flexible and which is part of a circumscription of the fluid chamber (85), wherein said expansion member (60, 65) is capable of compensating for variations of the volume of the fluids (86, 87) by keeping a pressure prevailing inside the fluid chamber (85) at a substantially fixed level, and wherein said expansion member (60, 65) comprises at least a portion of the sealing means (60).

2. Variable focus lens package (1) according to claim 1, wherein the expansion member (60, 65) further comprises a resilient member (65) for biasing the portion of the sealing means (60) which is part of the expansion member (60, 65) against the fluids (86, 87) inside the fluid chamber (85).

3. Variable focus lens package (1) according to claim 1, wherein at least a portion of the expansion member (60, 65) is slidably arranged with respect to a portion (18) of the surface of the body (10).

4. Variable focus lens package (1) according to claim 1, wherein at least a portion of the expansion member (60, 65) is slidably arranged with respect to a portion of a surface (36, 76) of one of the covers (30, 70).

5. Variable focus lens package (1) according to claim 1, wherein the portion of the sealing means (60) which is part of the expansion member (60, 65) comprises a sealing ring (60).

6. Variable focus lens package (1) according to claim 5, wherein the expansion member (60, 65) further comprises a resilient ring (65) surrounding the sealing ring (60).

7. Camera comprising a camera module (90) and a variable focus lens package (1) according to claim 1.

8. Hand-held apparatus comprising a camera according to claim 7, and further comprising input means, information processing means and display means.
